(19) United States
(12) Patent Application Publication
(10) Pub. No.: US 2003/0197602 A1
(43) Pub. Date: Oct. 23, 2003

(54) Prevention device for reckless driving of motor vehicle

(76) Inventor: Daniel Vasiliu-Rab, Revere, MA (US)

Correspondence Address: Daniel Vasiliu-Rab, 50 Avalon St., Revere, MA, 02151, US

(21) Appl. No.: 10/124,217

(22) Filed: Apr. 17, 2002

(51) Int. Cl. B60Q 1/00

(52) U.S. Cl. 340/441

(57) ABSTRACT

Preventive device for reckless driving of motor vehicles with instant:

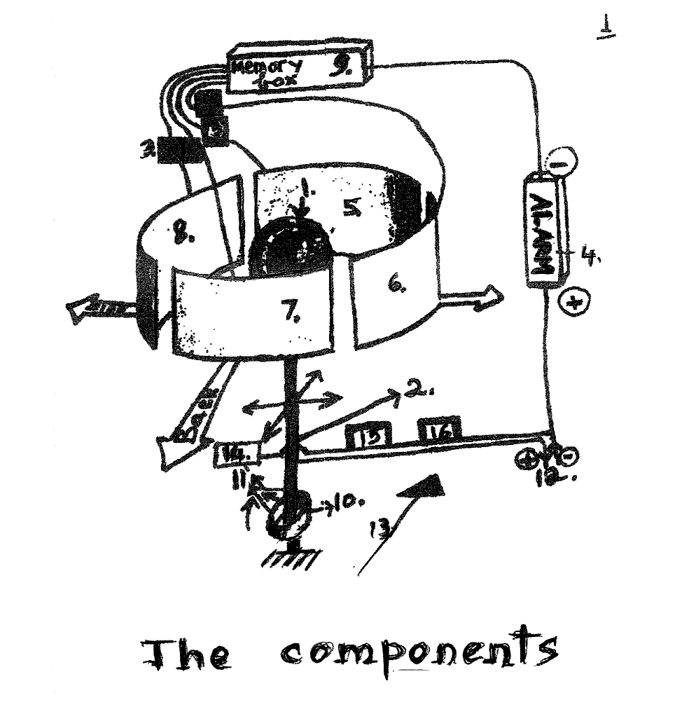

1. alarm (buzz),

2. voice message (to acknowledge the driver of inappropriate driving),

3. recording (memorizing),

4. evaluating (according with the memories data),

5. recommendations.

Provided:

for private use (unsealed device);

for official use (sealed device) to be used in legal considerations.

The device will recognize a change in the direction of driving (turning left or right) or a change in the speed (slowing down or accelerating) with negative effect for safety of driving and also will prevent premature wear and tear of the motor vehicle.

The device will alert the driver with:

1. an alarm (optional can be turn off-on):

2. a voice message will acknowledge the driver what kind of excessive maneuver done (optional to turn on-off):

3. a memory box will memorize the event with time and the speed off driving, and the length of driving.

4. will grade the way of driving;

5. will elaborate recommendations for certain periods of time according with the recorded driving history.

The memory box can be use as a:

separate device to be install by any person:

device to be install by authorized personal as a sealed device, which can not be altered to be considered by a third party who wants to evaluate drivers' habits (employer, auto insurance company)

The function principal relies on an electrical circuit which will be closed when the driving is in an excessive manner (regarding to change in speed and direction) closing the electrical circuit between components 1 and 5 (or 6, or 7, or 8) and also between components 2 and 10 (component 10 can also be made of four parts as the ensemble 5,6,7,8.

In the first step a PRE-excessive vehicle maneuver (accelerating-breaking, left-right turn) will close an electrical circuit at the level of components 2 and 10 which will alert (optional) the driver that “more” excessive maneuver will be label as “excessive”

This is the level of PRE-excessive maneuver which will not be recorded in memory box 9, but will help the driver to recognize the limits with alarm device #15 and a voice message #16, which are only on this electrical circuit

A PRE-excessive alarm and a proper voice voice-message will be given to the driver, which will be different to the excessive warning.

At this PRE-excessive level there is NOT contact between components 1 an ensemble 5,6,7,8.

In the second step an EXCESSIVE vehicle maneuver (accelerating-breaking, left-right turn), when the maneuver will be more aggressive then PRE-excessive one and will produce a more extended displacement of the component 1 towards circular ensemble 5,6,7,8 (due the centrifuge-centipede forces) and will close the electrical circuit (contact of component 1 and one of the components of the ensemble (5,6,7,8).

The components 5678 will be install in such of way that excessive breaking-acceleration and left-right turn will determine the contact of component 1 with a specific component (5 or 6 or 7 or 8) and will determine a component-specific acknowledgement (alarm, voice-message) and a component-specific memory, and recommendation.

For example considering the direction of movement of vehicle as in the attached drawing, as shown with arrow 13, pressing the breaks a “bit” excessive, will cause the component 2 (due the elastic characteristic of the component 2) first to create a contact between component 2 and component 10, which will close electrical circuit at this level but not at between components 1 and 5678 ensemble.

At the PRE-excessive level will determine component 14 to a PRE-excessive alarm, voice-message warning, different then excessive stage (see component 15 an 16).

If pressing the breaks too excessive will cause farther displacement and now the component 1 will touch the component 5. This will cause electricity to run through components of circuit 2 to 1 to 5 to 3 to 9 to 4 with the following effects

component 3 will initiate the message “excessive breaking”;

component 9 (memory box) will record the incident;

component 4 will produce a “buzz” (the alarm).

If following the same movement direction as shown by the arrow 13, and the vehicle will turn too excessive left speed, will cause a contact between components 1 and 6 and will be a “buzz” (the alarm) the message will be “excessive left turn”, will memorize as excessive left turn.

The component 8 in the electrical circuit will signalize too excessive right speed turn and 7 in the electrical circuit will signalize too much acceleration. Slowing down too fast will close the circuit with the plate #5 (the component 1 will be in contact with component 5).

What I claim as my invention is:

1. regarding excessive changing in speed (accelerating or breaking) and direction (left or right turn) of a motor vehicle the device will:
1. recognize it,
2. alert the driver when he/she reaches the limit for PREexcessive and excessive speed,
3. recording (memorizing),
4. evaluation of driving,
5. advising the driver according with his/her driving history.
I also claim that my invention will:
6. decrease the number of motor vehicle accidents,
7. the motor vehicle will function properly longer time,
8. decrease the cost for car insurance,
9. record data car for accident investigation, report.
